(19) United States
(12) Patent Application Publication
(10) Pub. No.: US 2003/0014478 A1
(43) Pub. Date: Jan. 16, 2003

(54) Dynamically distributed client-server web browser

(76) Inventor: Alan C. Noble, Santa Cruz, CA (US)

Correspondence Address: G. ROGER LEE, Fish & Richardson P.C., 225 Franklin Street, Boston, MA, 02110-2804, US

(21) Appl. No.: 09/896,264

(22) Filed: Jun. 29, 2001

(51) Int. Cl. G06F 15/173; G06F 15/16; G06F 9/00

(52) U.S. Cl. 709/203; 709/223

(57) ABSTRACT

A computing process wherein at least one server responds to requests from clients by returning information to clients, and wherein the computing process comprises initiating a request at a client, communicating the request to the server, responding to the request at the server by returning information to the client (wherein the information returned goes through at least parsing, layout, and rendering processes before being displayed at the client), configuring the software carrying out at least one of the parsing, layout, and rendering processes so that the location at which the process is performed can be changed between server and client at run time, making a load-balancing determination as to whether the process should be run at the server or client; and running the process at the chosen location.

### TECHNICAL FIELD

This invention relates to client-server computer systems, for example, web servers accessed by web browsers.

### BACKGROUND

In some client-server architectures, e.g., a web browser making requests of a web server, a series of processes, including fetching, parsing, layout, and rendering, are carried out in responding to a client request. A typical web browsing request will require that information be fetched from more than one web location (e.g. a requested web page may contain images stored at different web addresses than the page, itself).

Web pages are encoded in a markup language (e.g., HTML, XML, WML) that must be interpreted or parsed to determine what should be displayed at the client. The parsed document is often referred to as a document object module, or DOM, which is a collection of objects and their interfaces that defines a platform and language-neutral interface that allows programs and scripts to dynamically access and update the content, structure, and style of documents. The document can be further processed, e.g., by evaluating embedded scripts such as JavaScript, and the results of that processing can be incorporated back into the presented page. Parsing and fetching will, in general, overlap, as additional fetches can become necessary as a page is parsed.

Next comes the layout process, in which the layout engine queries the DOM for content, structure, and style information and specifies the placement of the content on the page. The data structures that represent the content placement are referred to as the layout.

The final process is rendering, in which the renderer (rendering engine) displays the formatted content of the layout on screen. It literally “paints” the browser's content area, which is the otherwise blank area inside the browser window.

Web browsers initiate requests of web servers by providing a Universal Resource Identifier (URI), which is a name or address that refers to a world-wide web (www) object, such as an HTML document. The most common kinds of URIs are Uniform Resource Locators (URLs) and relative URLs. URIs may have associated URI data that is used by the web server to prepare a response to the browser's request. URI data may be any input data associated with a request for a URI. For example, in the case of an HTTP URI, this is any combination of the following: query string data (for the GET method), form data (for the POST method), credentials for password-protected pages (e.g., BASIC or Digest Authentication), or cookies.

First generation web browsers accomplished all of the fetching, parsing, layout, and rendering processes at the client. These early web browsers were simple software programs that supported static HTML documents and little else. In contrast, modem web browsers are complex software systems that support a large variety of document types, such as HTML, xHTML, XML, CSS, RDF, JavaScript, WML, WMLScript, etc., and a rich set of features.

Until recently, web browsers ran almost exclusively on personal computers and were designed as single-process computer programs for a single user. Web browsers now run on a variety of operating systems, such as Microsoft Windows 98/2000/NT/me, Linux, Solaris and virtual platforms, such as Java. Some, such as Microsoft Internet Explorer (MSIE), have been ported to handheld computers, such as PocketPC. Nevertheless, full-featured browsers based on the single-process architecture require substantial computational resources in order to perform acceptably. Some browsers, such as Sun's Hot Java, run reasonably well on less powerful computers, but only by virtue of reducing the set of available features.

Web browsers have recently been developed based on a multi-user, client-server architecture in which browser functionality is split into processes distributed across multiple computers. The client-server browser architecture is well suited to handheld computers. The handheld computer executes the browser client process, which typically implements user interface functions for a single user. Server computers execute processes such as document fetching, caching and parsing for multiple users. For example, Wireless Application Protocol (WAP) browsers, also known as micro browsers, have been designed to run on digital wireless telephones over a variety of carrier networks. The WAP gateway is a server that fetches the WML document and parses (compiles) it, while the WAP browser displays it (performing both layout and rendering). The pumatech Browse-it product is another example of a client-server browser. The Browse-it server fetches, parses and lays out the document and the Browse-it client then displays it (rendering only). By offloading processing from the client to the server, the Browse-it client can run on less powerful computers, such the Palm Pilot, while still supporting rich document formats such as HTML with style sheets.

### SUMMARY

In general, the invention concerns dynamically distributing, between client and server, the various processes carried out by software (e.g., web browsers) in which information requested by a client goes through at least parsing, layout, and rendering processes before being displayed.

More specifically, the invention features, in general, a computing process wherein at least one server responds to requests from clients by returning information to clients, and wherein the computing process comprises initiating a request at a client, communicating the request to the server, responding to the request at the server by returning information to the client (wherein the information returned goes through at least parsing, layout, and rendering processes before being displayed at the client), configuring the software carrying out at least one of the parsing, layout, and rendering processes so that the location at which the process is performed can be changed between server and client at run time, making a load-balancing determination as to whether the process should be run at the server or client; and running the process at the chosen location.

One or more of the following features may be incorporated in preferred implementations of the invention.

The client-server computing process may be a web browsing process, and the server and clients a browser server and a browser client.

The browser server may communicate with a web server to retrieve information.

The load-balancing determination may be based at least in part on a quality of service determination of the quality of service provided by one or both of the client and server.

The quality of service determination may be based on latency of processes carried out on one or both of the client and server.

The load-balancing determination may be based at least in part on the load of one or both of the client and server.

The load-balancing determination may be based at least in part on the configuration of the clients.

The load-balancing determination may be further based at least in part on the configuration of the server.

The configuration on which the load-balancing determination may change dynamically and the load-balancing determination may respond dynamically to such changes.

The configuration on which the load-balancing determination may be assumed to remain static after a load-balancing determination based on such configuration is made.

The load-balancing determination may be based only on the configuration of the clients, and may remain fixed during operation.

The load-balancing determination may be based on both the configuration of the clients and a quality of service determination of the quality of service provided by one or both of the client and server.

The quality of service determination may be based on latency of processes carried out on one or both of the client and server.

The load-balancing determination may be based on both the configuration of the clients and on the load of one or both of the client and server.

Both the layout and parsing processes may be configured so that the location at which both processes are run may be changed between server and clients.

Clients with different configurations may use the same server so that an initial load balancing determination based on those configuration differences locates processes between client and server differently for differently configured clients.

During operation further changes may be made to the location at which processes are carried out based on quality of service determinations.

Latency may be measured using a timecard.

The processes that are carried out at either server or client may comprise distributed objects that migrate between client and server.

The objects may be Java Beans processed in containers.

The invention may further comprise a fetching process that can be run at either the client or the server based on the outcome of a load balancing determination.

The rendering process may always be performed at the client.

The invention may further comprise a script evaluation and execution process that can be run at either the client or the server based on the outcome of a load balancing determination.

Information may be cached at the client, and the type of information cached may be varied depending on which processes are running the client.

The load balancing determination may be based on one or more of the following: client computational resources, client load, server computational resources, server load, number of clients per server, network traffic between clients and server, and security.

The load balancing determination may be based on one or more of the following: latency of processing a request downstream/upstream from a given process, and latency of processing a request of a given process.

The processes may be pre-configured on the clients and server, so that they may be run on demand, by activating a process on one of the client and server, and deactivating the corresponding process on the other of the client and server, approximately simultaneously.

The ability to change the location at which processes are run may be locked to maintain the distribution of processes in a selected distribution.

The processes that run at the server may be interconnected by a switch.

The invention takes advantage of the recognition that web browsers and other types of software typically carry out a series of generally sequential processes, as listed in Table 1.

TABLE 1
Web browser subsystems

| Process | Input | Output |
|---|---|---|
| User | User events | URI to browse, URI data, etc. |
| Interface | | |
| Proxy | URI | Raw document (content, e.g., HTML, |
| server | JavaScript, or style info, e.g., CSS) | |
| Caching | URI | Cached document (page content + style |
| | | sheets) |
| Fetching | URI | Raw document |
| Parsing | Raw document | Parsed (compiled) document (DOM) |
| | (content & style | |
| | info) | |
| Evaluating | Parsed document | Parsed document (DOM) |
| | (DOM) | |
| Layout | Parsed document | Document layout |
| | (DOM) | |
| Rendering | Document layout | Rendered document for user interface |

Certain of these processes may be combined and/or omitted. For example, single-process desktop browsers usually do not include proxy server functionality, although they may be configured to connect to a proxy server rather than directly to web servers. Client-server browsers usually employ proxy servers to reduce external network traffic and improve performance by caching, thereby reducing fetch latencies. Further, layout and rendering are sometimes combined in simple browsers, and evaluation is only required when the document embeds scripts, such as JavaScript or WMLScript. Browsers may employ multiple caches.

As can be seen in FIGS. 1-5, which show various prior art web browsers, the data (represented by ovals) flowing between processes (represented by rectangles) is generally sequential and unidirectional (this is a simplification, as some overlap of processes occurs in practice and evaluation is omitted). This can be viewed as a pipelined architecture, for each component (process) reads streams of data on its input and produces streams of data on its output, generally delivering a complete instance of the result in a standard order. Thus, a web browser can be viewed as having six pipelined processes or stages (although, as noted, some overlap will occur in practice, and some browsers may have fewer or more stages): proxy server, fetching, parsing, layout, rendering, user interface.

FIG. 1 depicts a first-generation web browser in which all but the proxy server process are performed at the client. FIGS. 2-5 depict various client-server web browsers in which the interface between the browser server and the browser client moves progressively downstream, i.e., from left to right in the figures, as the client becomes thinner. This progression of clients can be termed very fat, fat, thin, and very thin (FIGS. 2-5, respectively). These names are useful mnemonics, but, of course, are quite arbitrary.

In all cases, the client sends the URI and required data to the server. The thinner the client becomes, the more highly processed is the reply from the server. At one extreme, the very fat client receives the raw document and is responsible for all document processing, namely parsing, layout and rendering. At the other extreme, the very thin client receives pre-rendered data and simply has to display it.

TABLE 2
Client types

| | | Request | |
|---|---|---|---|
| Figure | Client Type | (from client) | Reply (to client) |
| 2 | Very fat client | URI + data | Raw document |
| 3 | Fat client | URI + data | Parsed/compiled document |
| | | | (DOM) |
| 4 | Thin client | URI + data | Document layout |
| 5 | Very thin client | URI + data | Rendered display |

In prior-art web browsers, the interface between the client and server is fixed, having been determined by the design of the browser. For example, the Pumatech Browse-it™ product is a thin-client designed to process layout data in Pumatech Thin Client Data Exchange (TCDE) format. A WAP micro-browser is a fat client, designed to process compiled WML (application/vnd.wap.wml-wbxml) documents (WML layout and rendering is easier than HTML due to the simpler nature of WML). But with the invention, the interface is varied during operation to improve performance (e.g., quality of service).

The invention can be applied to web browsers that employ client-side caches, which are commonly employed in prior art browsers. The dashed line in FIGS. 2-5 represents the short-circuited data flow in the case when requested information is found in the client-side cache.

The distribution of processes between clients and servers may vary either statically depending on configuration criteria, or dynamically based on quality of service (QoS) criteria, or a combination of both, for example, when the initial configuration is specified by static parameters, but the subsequent configuration is dynamic based on quality of service. Dynamic configuration enables the browser to adapt to operating conditions, thereby optimizing performance and maximizing system scalability for a given network and its operating conditions.

Note that the invention describes how to distribute the functionality of the web browser, such that the browser itself performs well under load and adapts to failures. This is in contrast with prior art that describes how to distribute the functionality of a web server to fulfill requests from multiple web browsers. The notion of a distributed web browser is thus independent of the notion of a distributed web server. The former may be distributed without requiring that the latter to be distributed, or vice versa, or both systems may be distributed. FIGS. 13 and 14 illustrate the relationship of web server and web browser. FIG. 13 shows a monolithic web browser, in which all of the browsing processes are carried out on the client (e.g., the usual desktop browser). FIG. 14 shows a distributed web browser in which the browser function is distributed between a web browser client and a web browser server. In the prior art, the distribution of processes between the web browser client and web browser server was fixed. With the invention, the distribution is varied at run time.

The details of one or more embodiments of the invention are set forth in the accompanying drawings and the description below. Other features and advantages of the invention will be apparent from the description and drawings, and from the claims.

### DESCRIPTION OF THE DRAWINGS

FIGS. 1-5 are block diagrams showing the processes performed by prior art web browsers.

FIG. 6 is a block diagram of an embodiment of the invention in which a plurality of servers support a plurality of thin clients (parsing and layout processes performed at server).

FIG. 7 is a block diagram of another embodiment of the invention in which one server supports a plurality of fat clients (parsing performed at server, layout performed at client), and a plurality of other servers support a plurality of thin clients (parsing and layout performed at server).

FIG. 8 is a block diagram illustrating one embodiment of the manner in which the invention migrates a client-server process (e.g., parsing and/or layout) back and forth between client and server.

FIG. 9 is a block diagram illustrating the flow paths followed in completing server processes on a multi-server implementation of the invention, in which parsing and layout are performed at the server.

FIG. 10 is a block diagram illustrating the flow paths followed in completing server processes on a multi-server implementation of the invention, in the event of a failure of a server.

FIG. 11 is an event trace diagram depicting accumulated latency as recorded on a timecard following a first request.

FIG. 12 is an event trace diagram depicting accumulated latency as recorded on a timecard following a second request.

FIG. 13 is a block diagram illustrating a prior art web server and monolithic web browser connected across a network connection.

FIG. 14 is a block diagram illustrating a web server, web browser server, and web browser client, with network connections between both the web server and the web browser server, and between the web browser server and the web browser client. The diagram can describe either the prior art or the invention, depending on whether the distribution of processes between the web browser server and web browser client is fixed or dynamically varied, respectively.

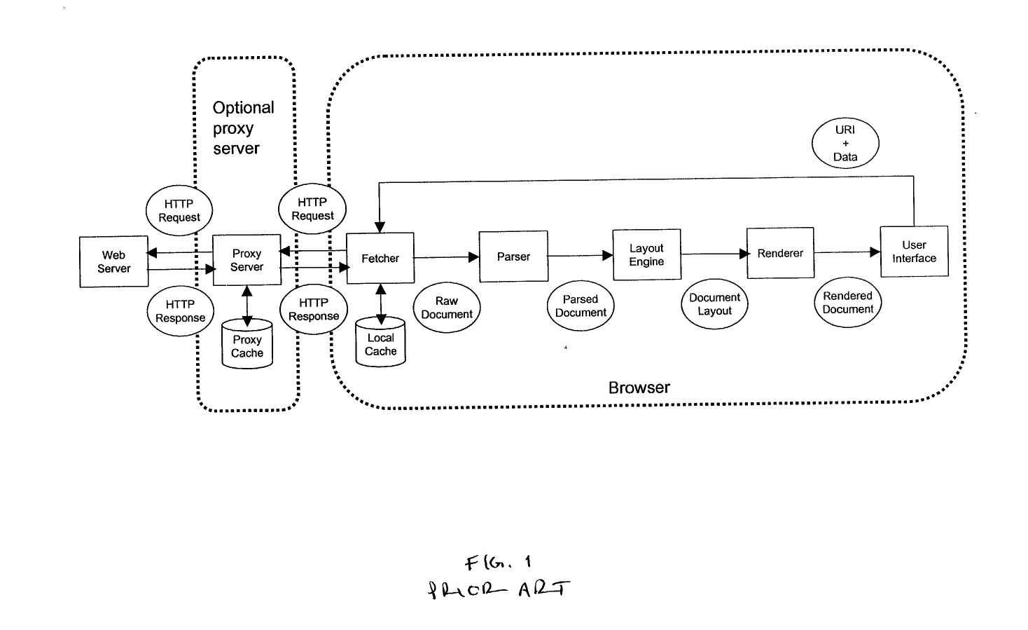

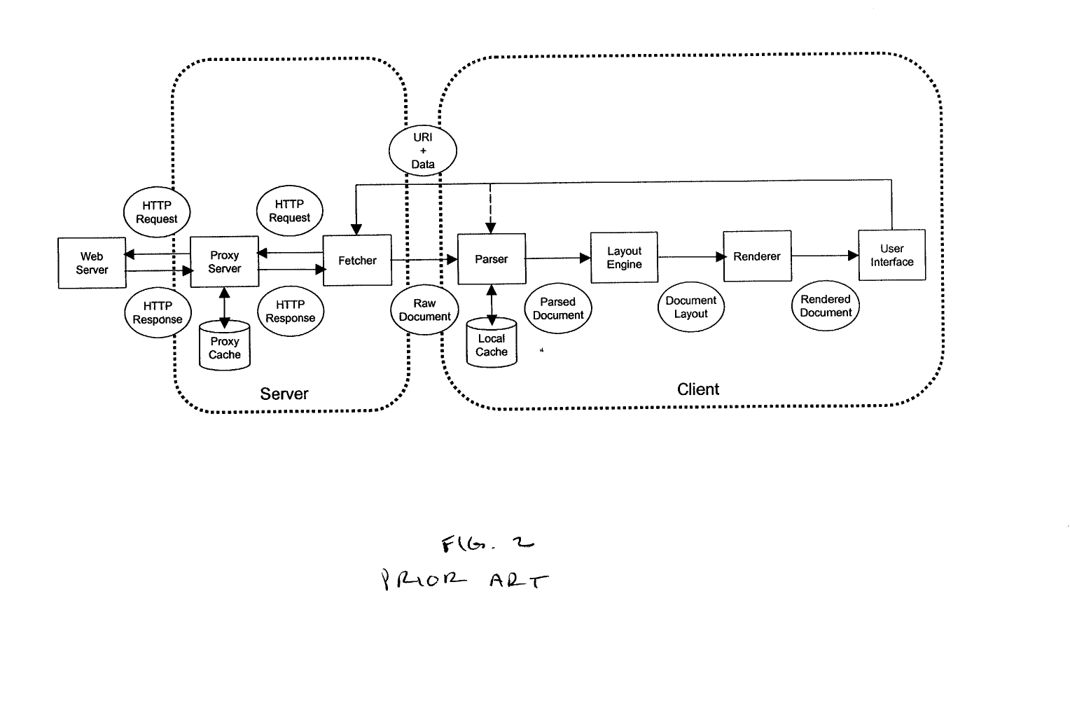

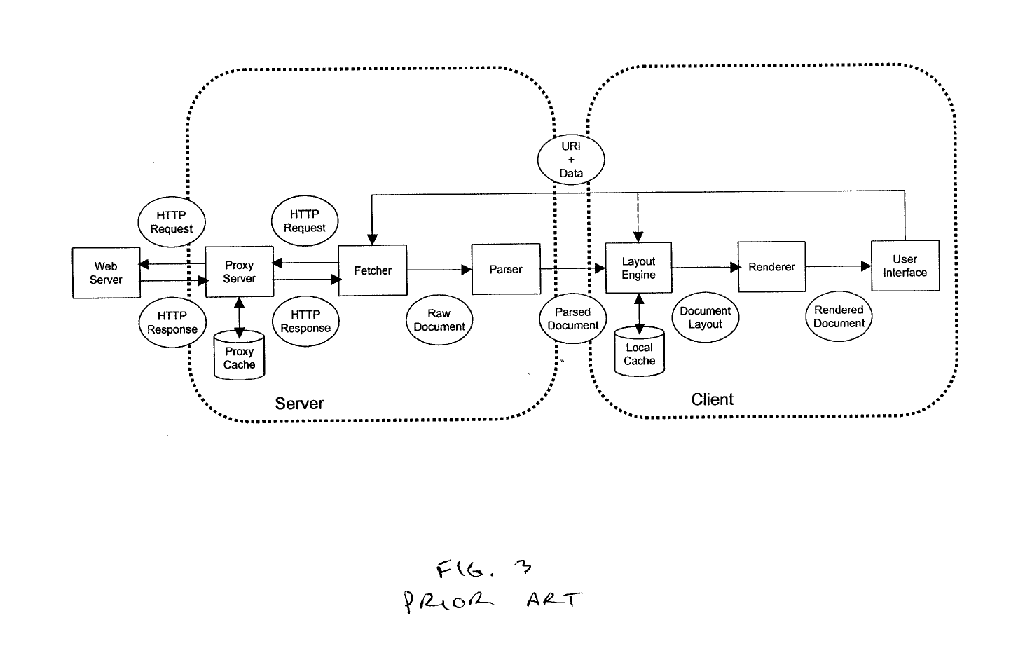

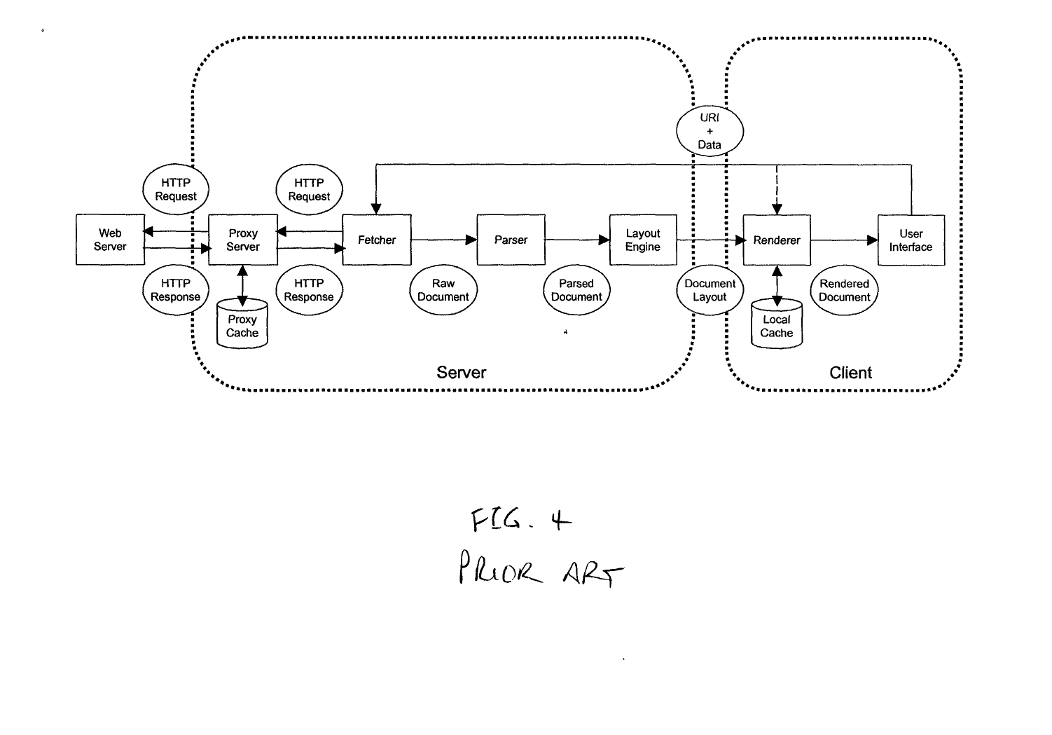

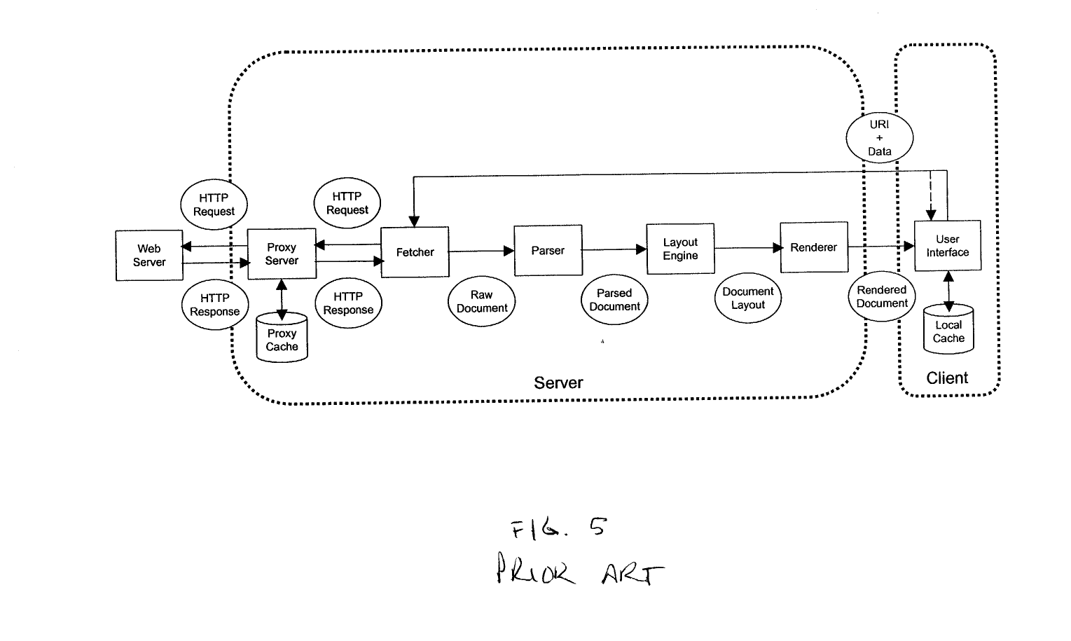

### DETAILED DESCRIPTION

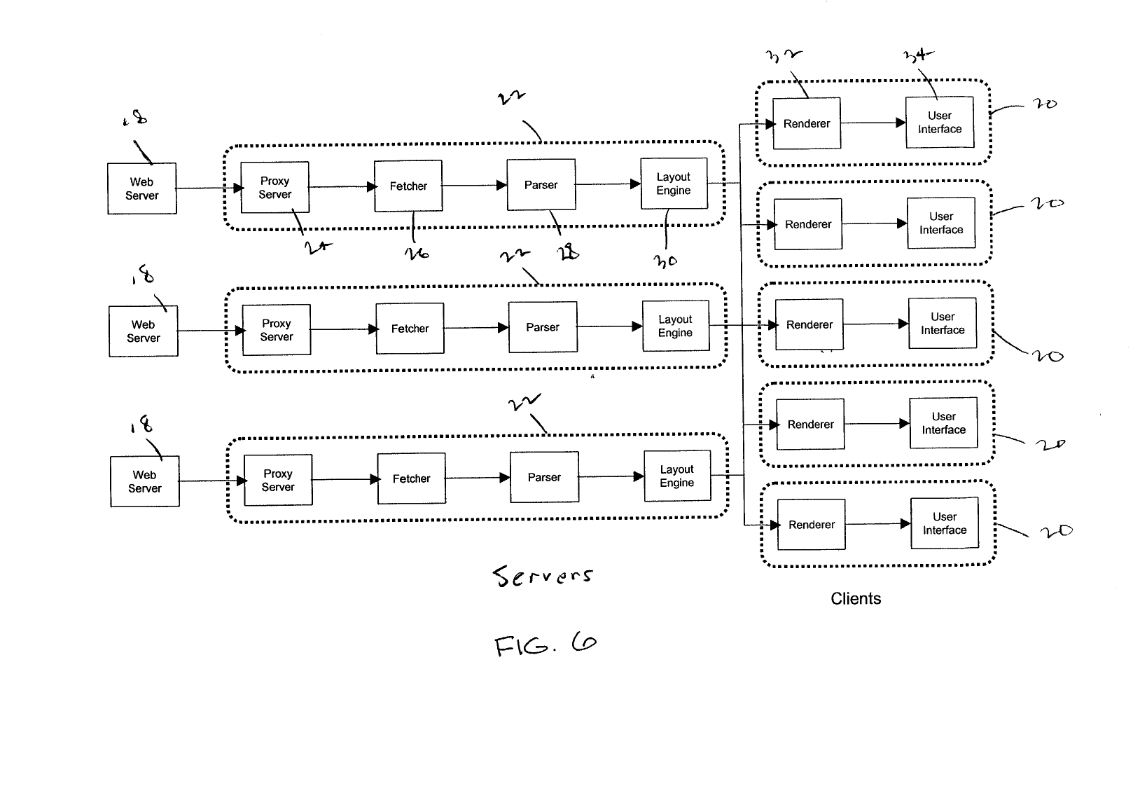

FIG. 6 depicts a homogeneous web browser system of browser clients 20 and browser servers 22, in which clients are all of the same type and network conditions are uniform for all clients (admittedly, something of a theoretical situation). Each server 22 has four subsystems or stages: proxy server 24, fetcher 26, parser 28, layout engine 30. Each client 20 has two subsystems: renderer 32 and user interface 34. Each browser server 22 is connected to a web server 18. In a dynamic homogeneous system, the client-server interface will move upstream as server load increases, thereby migrating work from servers to clients (e.g., the layout engine may migrate to the clients). In other words, servers will automatically push their work downstream to clients as their load increases. As server load decreases, for example, when the number of clients decreases, the client-server interface may move back downstream (e.g., the layout engine may move back to the servers).

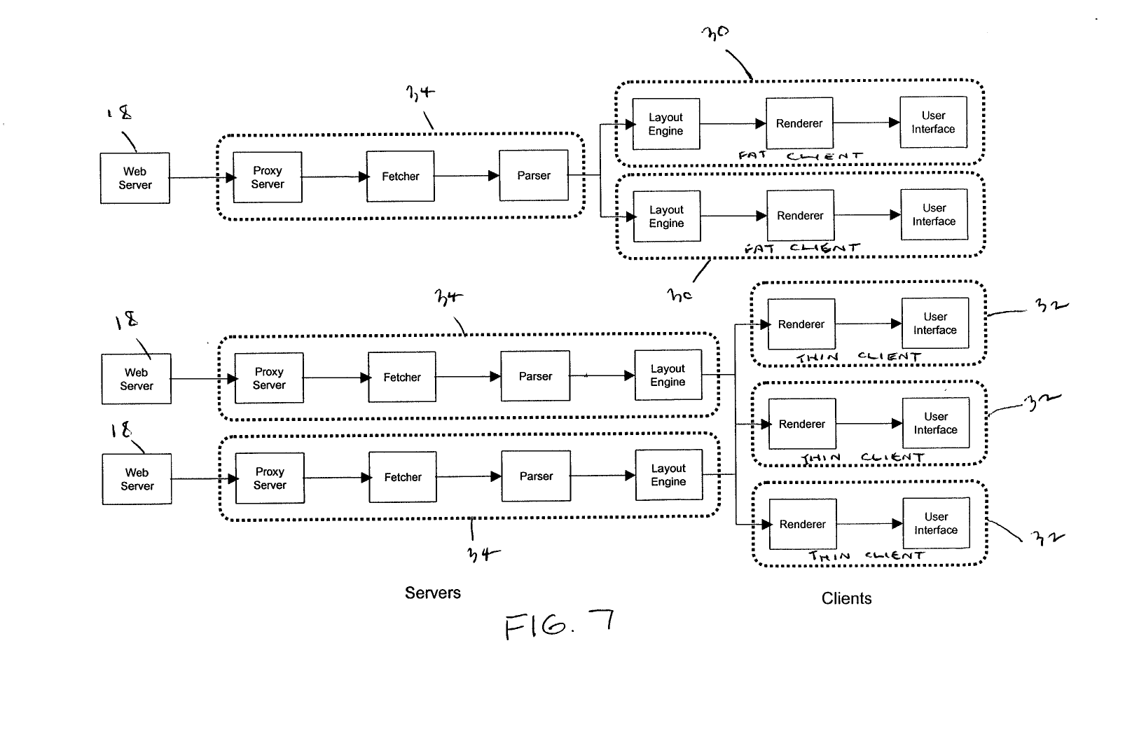

FIG. 7 depicts a heterogeneous web browser system of browser clients 30, 32 and browser servers 34, in which the browser clients are of two different types—fat clients 30 and thin clients 32—and network conditions possibly vary for different clients. The principles are the same as in the system of FIG. 7, except that the optimal client-server interface is no longer the same for all clients. The interface is further upstream if the clients are more powerful (e.g., for fat clients 30 ) and/or lightly loaded, or further downstream if the clients are less powerful (e.g., for thin clients 32) and/or highly loaded.

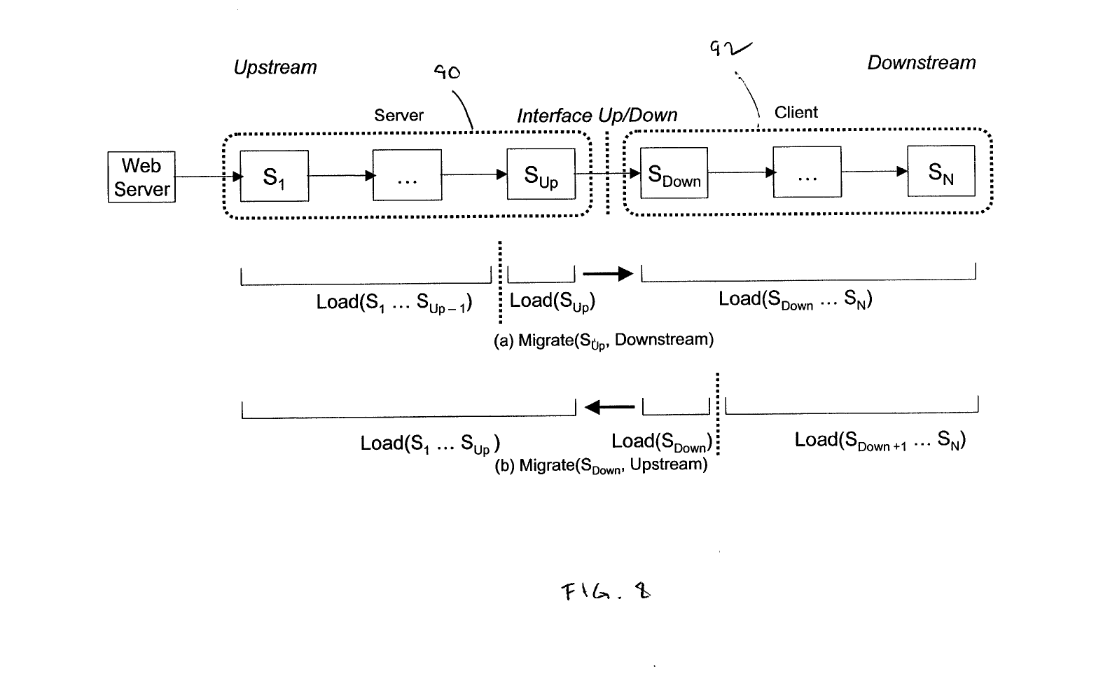

FIG. 8 depicts the basic concept of load balancing by use of subsystem migration. The subsystems that straddle the client/server interface are referred to as interface subsystems. Whenever the system is deemed to be unbalanced according to the given criteria, for example, when one side is over loaded, subsystems migrate across the interface and a new interface is automatically established.

Migration is defined herein to be the movement of computation, whether is physical by means of one or more objects being transferred, or logical by means of objects being activated and deactivated in tandem. For example, in practice, it is unlikely that subsystems would ever migrate physically from client to server. Rather, servers would likely be pre-configured with all applicable subsystems and activated upon demand. Similarly, in low-bandwidth networks, such as existing 2G wireless networks, it would be undesirable to physically transfer subsystems between client and server due to the adverse impact to the network.

Note that the current invention is independent of the underlying mechanisms used for implementing and distributing the computation. For example, subsystems could be readily implemented as Java Beans™ or distributed agents such as “Denizen” agents (U.S. Pat. No. 6,112,304)

The objects that the invention migrates back and forth across the client-server interface may also be subsystems or stages that undergo such migration. These objects, subsystems, or stages may also be referred to herein by reference to the process that the object, subsystem, or stage carries out.

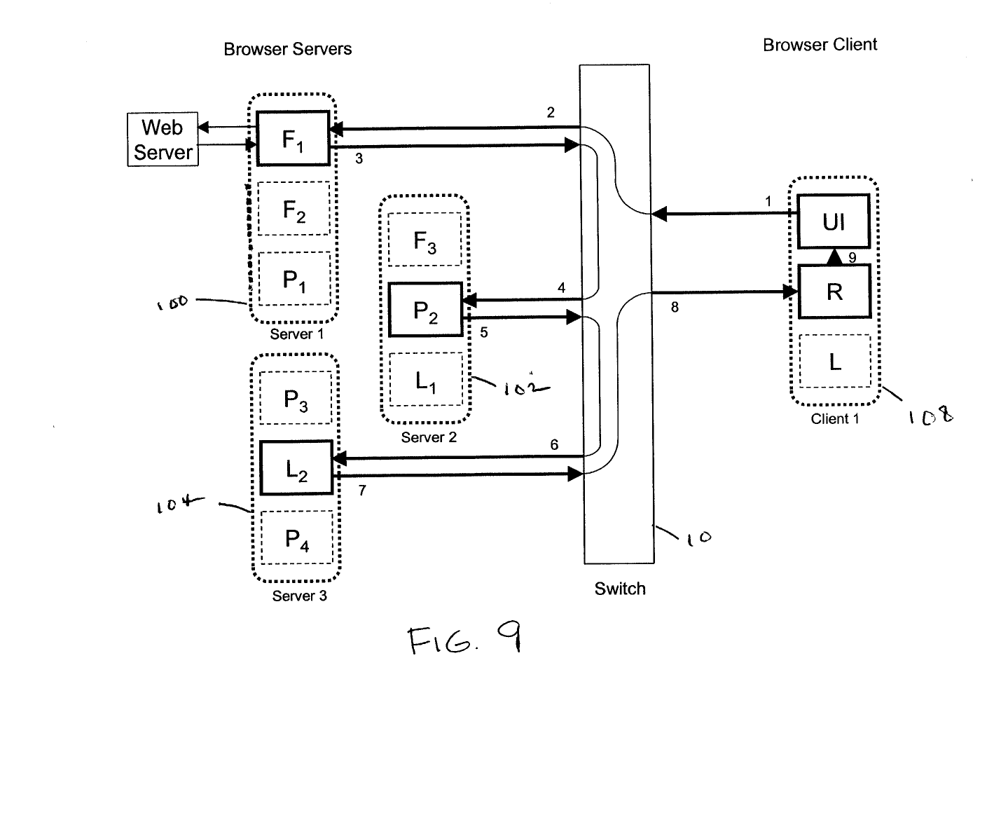

FIG. 8 depicts the migration process for a single server 90 (which could be a collection of physical servers controlled by a switch as in FIG. 9) and a single client 92. Objects active on the server are depicted generically as S1 through Sᵤₚ These could represent, for example, the fetching, parsing, and layout processes. Objects active on the client are depicted generically as S_{Down} through S_{N}. Similarly, these could represent the rendering and UI processes. The “Load” parameter represents the Quality of Service (QoS). One useful measure of Quality of Service (QoS) is latency, i.e., the time interval between a request and its response. Latency is a relevant metric since users ultimately care how fast the web browser responds to their requests, i.e., the time between inputting a URL into the UI and seeing the UI paint the result on the screen.

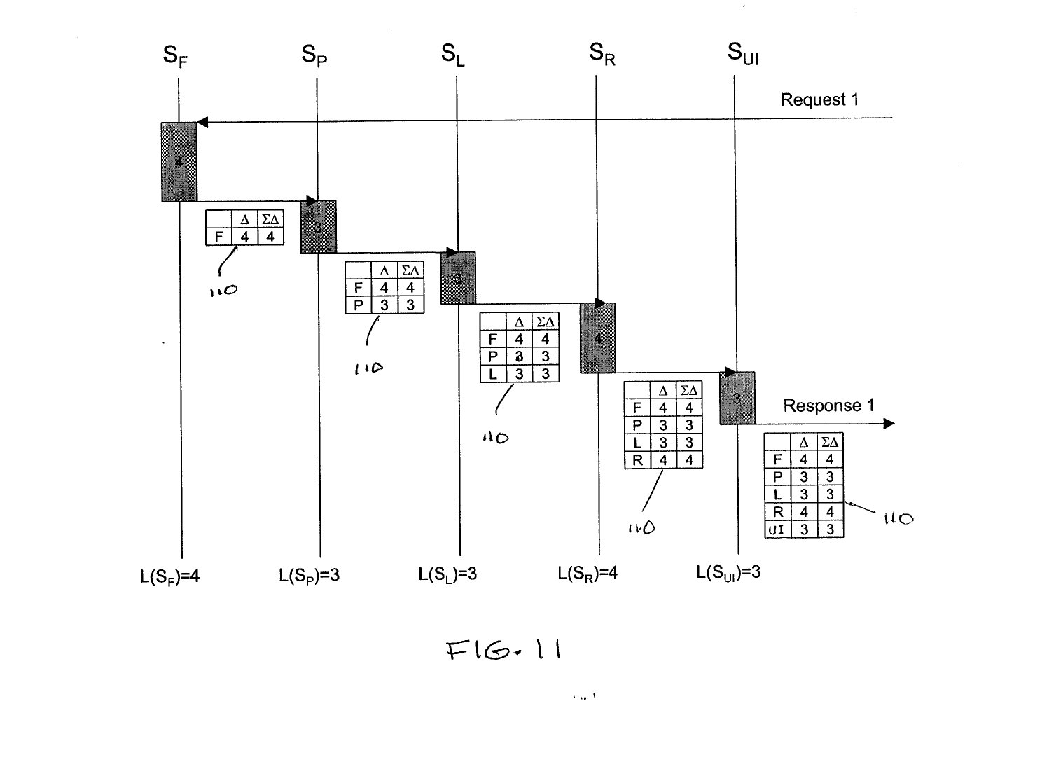

Various algorithms can be used to perform load balancing. For example, one simple algorithm for determining when to shed server load involves measuring latencies (see FIG. 11) and computing two moving averages, Lₙ, over the last n browser requests, and Lₘ over the last m browser requests, where n>>m (n is much greater than m). When Lₘ is approximately equal to Lₙ, (e.g., is within 10%), i.e., the latency is approximately constant over time, then servers are under loaded or at capacity, since servers are continuing to service requests as fast as the clients are generating them. When Lₘ is significantly greater than Lₙ, then the servers are overloaded and one or more Sᵤₚ subsystems should migrate downstream from server to client until the latency is again constant (albeit now higher).

FIG. 9 depicts the flow in a 5-stage system spanning 3 servers and 1 client. Fetching objects (F1, F2, F3), parsing objects (P1, P2, P3), and layout objects (L1, L2, L3) are located on three servers 100, 102, 104. Flow between objects is controlled by switch 106. Layout object L, rendering object R, and user interface UI are located at the client 108. Table 3 describes the events that take place in response to a user inputting a URI.

TABLE 3
Data Flow at Server

| Event | Description |
|---|---|
| 1 | User inputs a URI to UI and UI requests fetching |
| 2 | Switch forwards request to F1 |
| 3 | F1 completes fetch from a web server, and requests |
| | parsing |
| 4 | Switch forwards request to P2 |
| 5 | P2 completes parsing, and requests layout |
| 6 | Switch forwards request to L2 |
| 7 | L2 completes layout, and requests rendering |
| 8 | Switch forwards request to R |
| 9 | R completes rendering, replies to UI, and UI paints |
| | the result |

Objects not in active use are shown in dashed lines. Were the load distribution or quality of service (QoS) to require their use, e.g., to server other clients or to take up the load in the event of a server failure, these inactive objects could instantly be brought into use, as they are installed and ready.

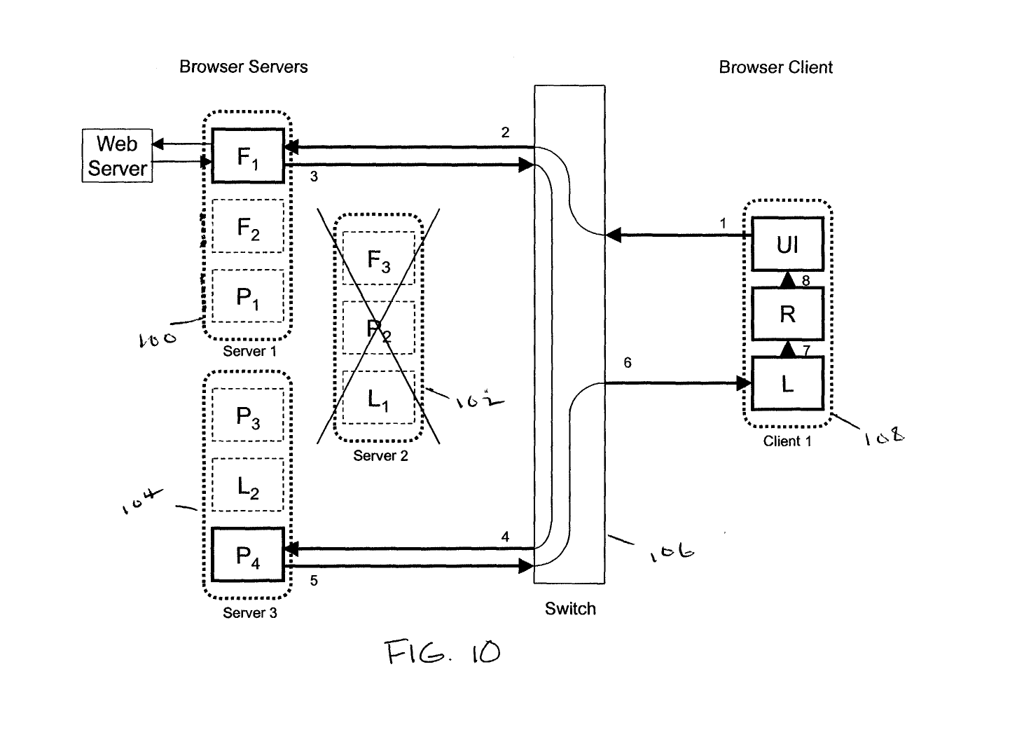

FIG. 10 depicts the above system dynamically reconfiguring after one server 102 has failed. Switch 106 directs layout to the layout object L on the browser client 108. Alternatively, the switch could have directed the layout request to the inactive layout object (L2) on server 104.

FIG. 11 depicts one embodiment in which latency data is propagated through the system by attaching a timecard (timesheet) parameter 110 to each request. Each of the five processing stages (fetching, parsing, layout, rendering, UR) keeps track of its start and finish time, and simply records on the timecard the time Δ it spent processing the request. In the example shown in FIG. 11, the fetching process took 4 time units, the parsing and layout processes each 3 time units, the rendering process 4 time units, and the UI process 3 time units. The timecard is also used to record the total accumulated time ΣΔ spent by each stage.

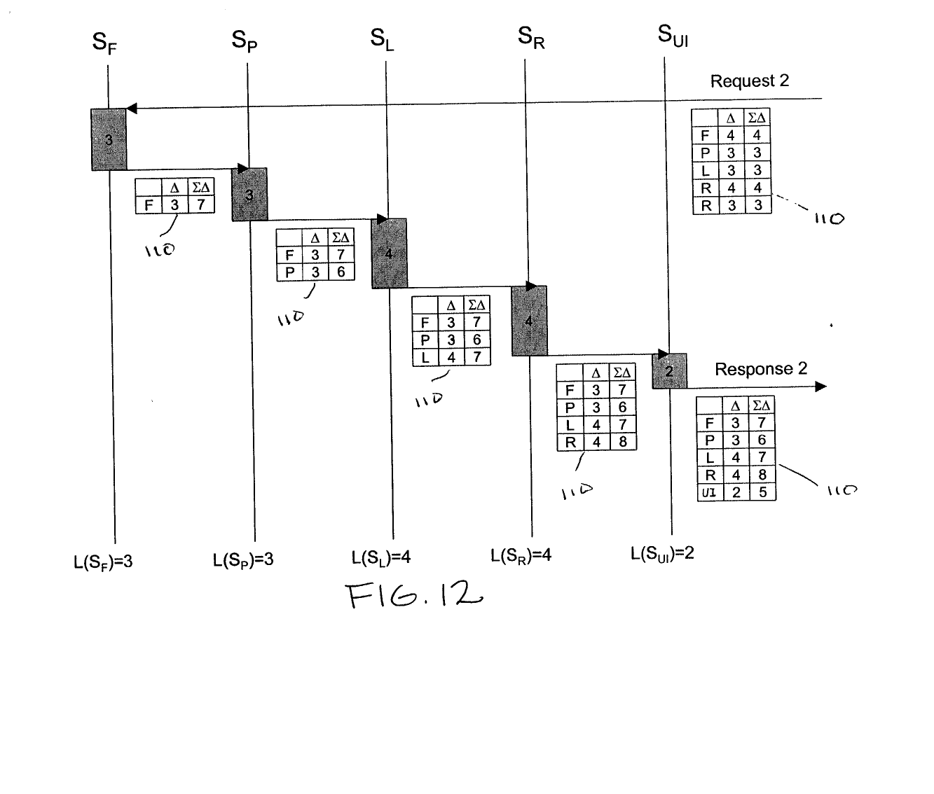

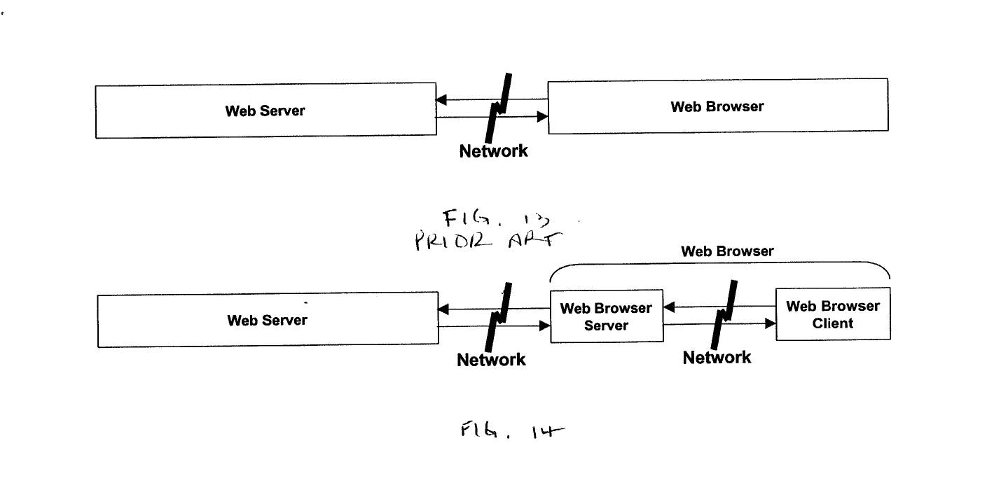

FIG. 12 shows the result after a second request is processed. The total accumulated time for fetching is 7 time units, for parsing 6 time units, for layout 7 time units, for rendering 8 time units, and for UI 5 time units. Alternatively, an average (e.g., a moving average) time per stage could be computed and stored on the timecard, or multiple totals or moving averages. Designated subsystems, such as the switch described earlier or separate time tracking subsystems, monitor the timecard to determine if, for example, one or more processes should migrate from server to client, or vice versa.

A number of embodiments of the invention have been described. Nevertheless, it will be understood that various modifications may be made without departing from the spirit and scope of the invention.

For example, although the invention has been described in terms of a web browser, it is applicable to other client-server processes in which information returned to a client goes through at least parsing, layout, and rendering processes. The number and variety of processes that migrate between server and client can be varied (others not mentioned could be added, and two or more of those described could be consolidated into a single process).

An example of an additional process that could migrate between client and server is evaluation and execution of scripts (e.g., JavaScript or WMLScript). Ordinarily, this process would occur between parsing and layout. A script evaluator would be installed at both client and server, so that scripts could be processed at either location depending on load.

The invention is not limited to any particular type of information requested from the server. As applied to web browsers requesting information from web servers, the information could include both static web pages as well as pages assembled from databases.

Any type of data representation could be used for communications between the web browser server and the web browser client (e.g., the industry standard XML format or the proprietary binary format known as TCDE used by Browse-It).

Any measure of load, quality of service, or other system performance can be used as the basis for making the load-balancing determination to decide whether to move the location of a process from client to server or vice versa. The terms “load”, “load balancing”, and “quality of service” should be interpreted broadly, and not limited to specific meanings of those terms as may be found in the computer software field.

As noted elsewhere, the decision to locate a process at a server or client may be based not only on measurements of system performance, e.g., load or quality of service, but can also be made on the basis of the configuration of the servers and/or the clients. And since configurations can change, the invention may respond dynamically to such changes in configuration.

Accordingly, other embodiments are within the scope of the following claims.

1. A client-server computing process wherein at least one server responds to requests from clients by returning information to clients, the computing process comprising:
initiating a request at a client;
communicating the request to the server;
responding to the request at the server by returning information to the client, wherein the information returned goes through at least parsing, layout, and rendering processes before being displayed at the client;
configuring the software carrying out at least one of the parsing and layout processes so that the location at which the process is performed can be changed between server and client at run time;
making a load-balancing determination as to whether the process should be run at the server or client; and
running the process at the chosen location.

2. The computing process of claim 1 wherein the client-server computing process is a web browsing process, and the server and clients are a browser server and a browser client.

3. The computing process of claim 2 wherein the browser server communicates with a web server to retrieve information.

4. The computing process of claim 1 wherein the load-balancing determination is based at least in part on a quality of service determination of the quality of service provided by one or both of the client and server.

5. The computing process of claim 4 wherein the quality of service determination is based on latency of processes carried out on one or both of the client and server.

6. The computing process of claim 1 wherein the load-balancing determination is based at least in part on the load of one or both of the client and server.

7. The computing process of claim 1 wherein the load-balancing determination is based at least in part on the configuration of the clients.

8. The computing process of claim 7 wherein the load-balancing determination is further based at least in part on the configuration of the server.

9. The computing process of claim 7 or 8 wherein the configuration on which the load-balancing determination is based changes dynamically and the load-balancing determination responds dynamically to such changes.

10. The computing process of claim 7 or 8 wherein the configuration on which the load-balancing determination is based is assumed to remain static after a load-balancing determination based on such configuration is made.

11. The computing process of claim 7 wherein the load-balancing determination is based only on the configuration of the clients, and remains fixed during operation.

12. The computing process of claim 7 wherein the load-balancing determination is based on both the configuration of the clients and a quality of service determination of the quality of service provided by one or both of the client and server.

13. The computing process of claim 12 wherein the quality of service determination is based on latency of processes carried out on one or both of the client and server.

14. The computing process of claim 7 wherein the load-balancing determination is based on both the configuration of the clients and on the load of one or both of the client and server.

15. The computing process of claim 1 wherein both the layout and parsing processes are configured so that the location at which both processes are run may be changed between server and clients.

16. The computing process of claim 1 wherein clients with different configurations use the same server so that an initial load balancing determination based on those configuration differences locates processes between client and server differently for differently configured clients.

17. The computing process of claim 16 wherein during operation further changes are made to the location at which processes are carried out based on quality of service determinations.

18. The computing process of claim 5 wherein latency is measured using a timecard.

19. The computing process of claim 1 wherein the processes that are carried out at either server or client comprise distributed objects that migrate between client and server.

20. The computing process of claim 19 wherein the objects are Java Beans processed in containers.

21. The computing process of claim 1 further comprising a fetching process that can be run at either the client or the server based on the outcome of a load balancing determination.

22. The computing process of claim 1 wherein the rendering process is always performed at the client.

23. The computing process of claim 1 further comprising a script evaluation and execution process that can be run at either the client or the server based on the outcome of a load balancing determination.

24. The computing process of claim 1 wherein information is cached at the client, and the type of information cached varied depending on which processes are running the client.

25. The computing process of claim 1 wherein the load balancing determination is based on one or more of the following: client computational resources, client load, server computational resources, server load, number of clients per server, network traffic between clients and server, and security.

26. The computing process of claim 1 wherein the load balancing determination is based on one or more of the following: latency of processing a request downstream/upstream from a given process, and latency of processing a request of a given process.

27. The computing process of claim 1 wherein the processes are pre-configured on the clients and server, so that they may be run on demand, by activating a process on one of the client and server, and deactivating the corresponding process on the other of the client and server, approximately simultaneously.

28. The computing process of claim 1 wherein the ability to change the location at which processes are run may be locked to maintain the distribution of processes in a selected distribution.

29. The computing process of claim 1 wherein the processes that run at the server are interconnected by a switch.
